(19) United States
(12) Patent Application Publication
(10) Pub. No.: US 2023/0049328 A1
(43) Pub. Date: Feb. 16, 2023

(54) CLAMPING MECHANISM FOR 3D PRINTING BUILD PLATE

(71) Applicant: Xerox Corporation, Norwalk, CT (US)

(72) Inventors: Prasanth Kalaiselvan, Chennai (IN); Karthik Mani, Chennai (IN); Jagan Thiyagarajan, Chennai (IN); Naveenkumarreddy Challa, Chennai (IN)

(21) Appl. No.: 17/400,916

(22) Filed: Aug. 12, 2021

(51) Int. Cl. B29C 64/245; B29C 64/236; B29C 64/232; B33Y 30/00

(52) U.S. Cl. CPC B29C 64/245; B29C 64/236; B29C 64/232; B33Y 30/00

(57) ABSTRACT

A build plate supported on a movable carriage of a 3D printing machine includes a plurality of clamping surfaces that are engageable by a mechanical clamping system that includes a plurality of clamp assemblies mounted on the movable carriage. Each of the clamp assemblies is associated with a corresponding clamping surface and includes a clamping arm configured to rotate and translate to selectively engage the corresponding clamping surface, a follower arm configured to rotate, and a conversion mechanism configured to convert rotation of the follower arm to rotation and translation of the clamping arm. An actuation mechanism includes an actuation face, corresponding to each follower arm. The actuation mechanism is arranged to simultaneously exert a force against the follower arm of each of the clamp assemblies to rotate the follower arm as the carriage moves from a working station to an unloading station of the 3D printing machine. The conversion mechanism then converts the rotation of the follower arm of each clamping assembly to rotation and translation of the respective clamping arm to selectively and simultaneously engage and disengage the clamping surfaces of the build plate.

### TECHNICAL FIELD

This disclosure relates to 3D or additive printing machines and particularly to mechanisms for releasably clamping the build plate.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use extrusion printing in which an extrusion printhead emits a melted build material, such as a heated and softened metal or plastic, in a predetermined pattern. The printer typically operates the extrusion printhead to form successive layers of the build material that form a three-dimensional printed object with a variety of shapes and structures.

In a 3D metal printing machine, such as the machine M shown in FIG. 1, a print head H deposits the build material B on a build plate 10. As the molten metal is being deposited on the build plate, the plate 10 must be clamped or held in a fixed position as the printhead H moves relative to the surface of the build plate according to the predetermined pattern. In some machines, the build plate 10 can be lowered as each successive layer of the build B is deposited onto the build plate. Once the build is complete, a drive or transfer mechanism T can move the build plate away from the print head H to an unloading station of the 3D printing machine M. The transfer mechanism T can be electrically, hydraulically or pneumatically powered. The build plate is unclamped so that the build plate can be removed with the completed build. In other words, the build plate moves between a working station underneath the print head and the unloading station.

In a typical 3D printing machine, the build plate is held in place by pneumatic or hydraulic clamps. When the printing machine is a metal printing machine, the temperatures are necessarily very high in order to melt the metal for deposition onto the build plate. In this extreme environment, many pneumatic or hydraulic actuators will fail or work improperly, which can impact the clamping and unclamping action.

There is a need for a clamping mechanism that can operate reliably in the high-temperature environment of a 3D metal printing machine. It is also desirable that the clamping mechanism have a low profile to readily accommodate the space constraints in the printing machine.

### SUMMARY OF THE DISCLOSURE

A build plate supported on a carriage of a 3D printing machine that is movable by a powered drive or transfer mechanism between a working station beneath the print head of the 3D printing machine, and an unloading station in which the build plate is removed from the machine. The build plate includes a plurality of clamping surfaces that are engageable by a mechanical clamping system that is automatically operable to clamp and unclamp the build plate as the carriage moves within the printing machine.

In one feature, the clamping system includes a plurality of clamp assemblies mounted on the movable carriage. Each of the clamp assemblies is associated with a corresponding clamping surface and each includes a clamping arm configured to rotate and translate to selectively engage the corresponding clamping surface, a follower arm configured to rotate, and a conversion mechanism configured to convert rotation of the follower arm to rotation and translation of the clamping arm. An actuation mechanism includes an actuation face corresponding to each follower arm. The actuation mechanism is configured and arranged to simultaneously exert a force against the follower arm of each of the clamp assemblies to rotate the follower arm as the carriage moves from a working station to an unloading station of the 3D printing machine. The conversion mechanism then converts the rotation of the follower arm of each clamping assembly to rotation and translation of the respective clamping arm to selectively and simultaneously engage the clamping surfaces of the build plate. The conversion mechanism is configured to simultaneously disengage the clamping surfaces of the build plate as the carriage is driven by the powered transfer mechanism from the unloading station to the working station of the 3D printing machine.

In one aspect, the conversion mechanism includes a biasing spring that biases each clamping arm to the clamped position relative to the build plate. The actuation mechanism includes a plurality of stationary actuation blocks, each having an actuation face that is configured to bear against a corresponding follower arm of the clamping assemblies when the build plate carriage moves toward the unloading station. For some of the clamping assemblies, the actuation face is incorporated into an actuation plate mounted to a rod in which the rod contacts one of the stationary actuation blocks as the carriage moves to the unloading station. The actuation mechanism thus works against the biasing spring to move each clamping arm to the unclamped position.

In one aspect of the clamping system, the force required to move the actuation mechanism and the clamp assemblies is provided by the drive or transfer mechanism of the 3D printing machine. In particular, the present clamping system does not require its own source of power to disengage the clamp assemblies from the build plate. The force to return the clamping assemblies to the clamping position is generated by a passive component, namely a biasing spring.

### DESCRIPTION OF THE FIGURES

The foregoing aspects and other features of a system and method that enable ink within a printhead to maintain a low viscosity state during periods of extended inactivity are explained in the following description, taken in connection with the accompanying drawings.

FIG. 1 is a front view of a 3D printing system with a build plate to be clamped by the clamp assembly disclosed herein.

FIG. 2 is a top perspective view of the build plate being clamped by the clamp assemblies disclosed herein.

FIG. 3 is a top perspective view of the build plate being unclamped by the clamp assemblies disclosed herein.

FIGS. 4A-4B are perspective views of the clamp assemblies and actuation mechanisms shown in FIGS. 2-3.

FIG. 5 is an enlarged view of a follower arm of the clamp assemblies shown in FIGS. 4A-4B.

FIG. 6A is a side view of the cylinder of a clamp assembly shown above.

FIG. 6B is a side view of the clamp assembly shown with the assembly in its clamped position.

FIG. 6C is a side view of the clamp assembly shown with the assembly in its clamped position.

FIG. 6D is a view of the interior of the clamp assembly shown in FIG. 6B.

FIG. 7 is a top perspective view of the build plate and clamp assemblies mounted on a carriage of the 3D printing system shown in FIG. 1.

FIG. 8 is an enlarged side view of the actuation rod of the actuation mechanism shown in FIGS. 4A-4B.

FIG. 9 is an end perspective view of the build plate and clamp assemblies in the unclamped position within the 3D printing system.

FIG. 10 is a side perspective view of the build plate and clamp assemblies shown in the unclamped position as in FIG. 9.

FIGS. 11A, 11B are side cut-away view of the build plate and clamp assemblies in the clamped position within the 3D printing system.

FIGS. 12A, 12B are side cut-away view of the build plate and clamp assemblies in the unclamped position within the 3D printing system.

FIG. 13 is a side partial cut-away view of the build plate and clamp assemblies showing the difference in clamp and spring position of the clamp assemblies between the clamped and the unclamped positions.

### DETAILED DESCRIPTION

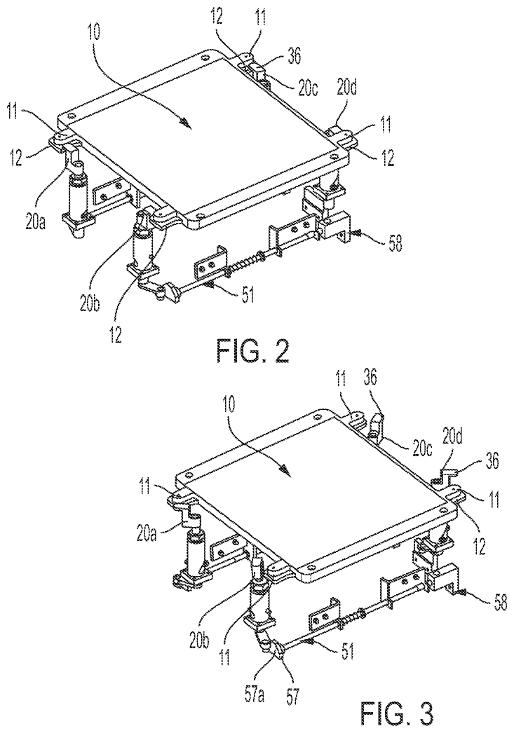

In one aspect of the disclosure, a plurality of clamp assemblies 20 are provided to releasably clamp the build plate 10 in a 3D printing machine, such as the machine M. The build plate 10 includes a plurality of tangs 11, each defining a ledge 12. In one embodiment, the plate 10 is rectangular with four such tangs 11 at corner of the plate, as shown in FIGS. 2-3. As described herein, a clamp assembly 20 is provided at each corner to engage the corresponding tang 11, and specifically the ledge 12 of the corresponding tang. Thus, in the engaged position shown in FIG. 2, the clamp assemblies simultaneously engage the ledges 12 of the tangs 11 to fix the position of the build plate 10 beneath the print head H of the 3D printing machine M. As shown in FIG. 3, the clamp assemblies 20a-20d can be moved to a release position in which the tangs 11 are no longer engaged by the clamp assemblies, so that the build plate 10 is free to be removed. As explained herein, the clamp assemblies 20a-20d are configured to be moved to the engaged or disengaged positions simultaneously.

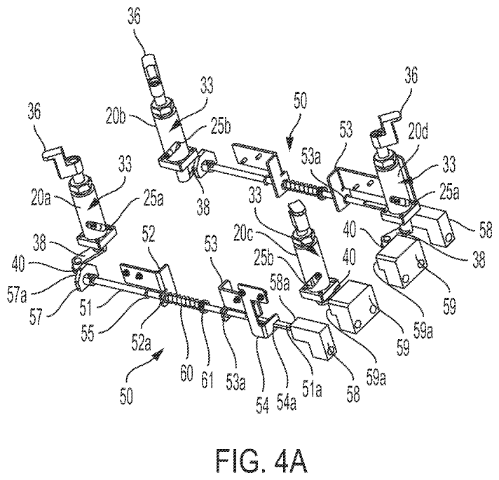

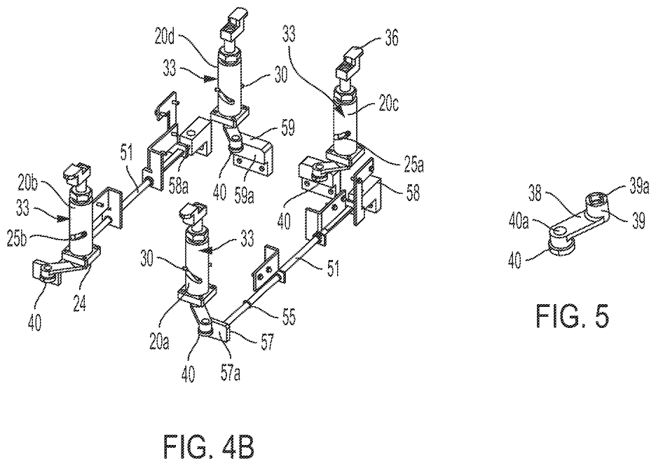

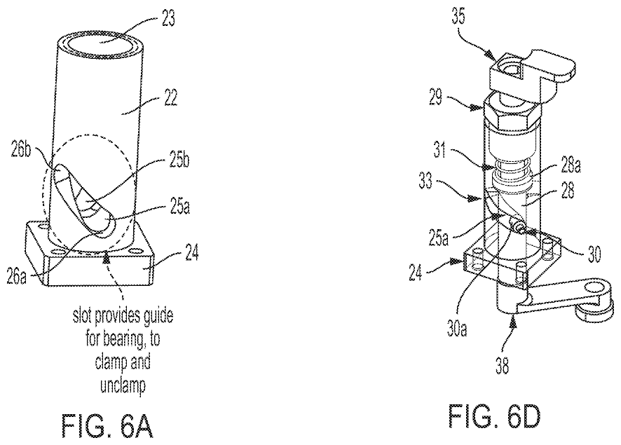

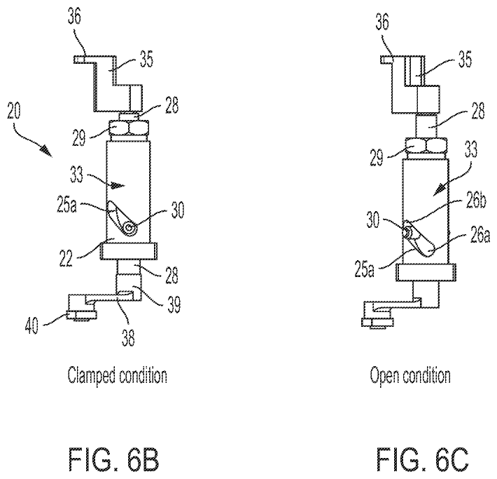

Details of the clamp assembly 20 are shown in FIGS. 4-6D. Each clamp assembly 20 (20a-20d) includes a cylinder 22 extending from a base 24. The cylinder defines a bore 23 along its longitudinal axis for rotatably receiving a shaft 28 supported by a bearing mount 29 that is fastened to the cylinder. The cylinder defines a pair of diametrically opposed slots 25a, 25b that are angled upward relative to the base 24, as best shown in FIG. 6A. The slots are non-colinear and non-perpendicular relative to the longitudinal axis of the cylinder so that one end 26a of each slot is lower than the opposite end 26b of the slot relative to the cylinder. In one specific embodiment, the slots 25a, 25b are arranged at a 45° angle relative to the longitudinal axis. The slots 25a, 25b receive a transverse guide pin 30 fixed within the shaft 28. In particular, the transverse pin 30 includes two bushings 30a (FIG. 6D) that slide within the slots. The movement of the transverse pin 30 is thus limited to movement within the two slots. In particular, as the shaft 28 rotates the transverse pin 30 moves from a position at the lower end 26a of the slots, as shown in FIG. 6B, to a position at the top end 26b of the slots, as shown in FIG. 6C. Since the transverse pin is fixed within the shaft, this movement of the pin necessarily translates the shaft vertically upward within the cylinder 22, as reflected in the amount of the shaft 28 projecting above the top of the cylinder in FIGS. 6B and 6C. As shown in FIG. 6D, a biasing member in the form of a spring 31 is disposed between the bearing mount 29 and a hub 28a affixed to the shaft 28. The spring 31 provides a downward biasing force to push the shaft 28 downward, and thus push the transverse pin 30 toward the bottom of the slots 25a, 25b. The biasing spring 31 thus biases the clamp assembly to the clamping position described below.

The clamp assembly 20 further includes a clamp 35 mounted to the top of the shaft 28, as shown in FIGS. 6B-D. The clamp 35 includes a clamp arm 36 that extends generally perpendicularly outward relative to the shaft 28. It can be appreciated that rotation of the shaft 28 leads to rotation of the clamp and clamp arm 36 from an engaged or clamping position, as shown in FIG. 2, to a disengaged or unclamping position, as shown in FIG. 3. In the clamping position of FIG. 2, the clamp arm 36 engages the ledge 12 of the corresponding tang. In the engaged position, the transverse pin 30 is at the bottom end 26a of the slots 25a, 25b (FIG. 6B) so that the clamp 35 and clamp arm 36 is at its lowest position relative to the cylinder. This lowermost position allows the clamp arm 36 to exert a downward force on the tang 11, which force holds the build plate 10 in position. Alternatively, when the shaft 28 and, ultimately the clamp arm 36, is rotated, the pin 30 travels to the top end 26b of the slots, thereby elevating the clamp arm away from the tang 11 of the build plate 10. Thus, the clamp arm 36 not only rotates into and out of engagement with the tang, the lamp arm also lowers or raises relative to the tang, between the clamped position of FIGS. 2, 6B and the unclamped position of FIGS. 3, 6C. The clamp assemblies 20 thus operate by simultaneously rotating and translating the clamp 35 and clamp arm 36 up and away from the tangs 11 to release the build plate 10 and down and toward the tangs to clamp the build plate.

The shaft 28, and therefore the clamp arms 36, of the clamp assemblies 20a-20d are rotated by way of a follower arm 38 connected to the bottom of the shaft 28 at a hub 39, as shown in FIG. 6B. It is contemplated that the hub 39 is fixed to the shaft to rotate and translate with the shaft. As shown in more detail in FIG. 5, the hub 39 defines a bore 39a that is non-circular, such as a hex-bore, to engage a complementary configured portion of the shaft 28. This feature requires that the shaft rotate with the hub 39 of the follower arm 38. Alternatively, the hub bore 39a can form a telescoping engagement with the shaft so that the follower arm 38 and shaft rotate together but the shaft can translate along the longitudinal axis independent of the follower arm and hub 39.

The follower arm projects perpendicularly outward from the concentric longitudinal axes of the shaft and cylinder. The follower arm 38 includes a roller 40 rotatably mounted at the opposite end of the arm from the hub. Again, as shown in FIG. 5, the roller can be rotatably mounted on a post 40a that is fixed within a bore defined in the end of the arm. It can be appreciated that the post itself may be rotatably mounted within the bore. Alternatively, the roller 40 can be fixed against rotation, but rotation is preferred to reduce wear on the roller in use, as described herein. In particular, the roller 40 is the point of contact of the clamp assembly 20 with an actuation mechanism 50 that simultaneously rotates the shafts 28 of all of the clamp assemblies by exerting a force against the follower arms.

Each clamp assembly 20 mechanically converts movement of the follower arm 38 to movement of the clamp arm 36. In particular, each clamp assembly converts rotation of the follower arm 38 to rotation and vertical translation (raising and lowering) of the clamp arm 36. In this respect, the cylinder 22, slots 25a, 25b, shaft 28 and transverse guide pin 30 constitute a conversion mechanism 33 converts movement of the follower arm into clamping and unclamping movement of the clamp arm relative to the build plate.

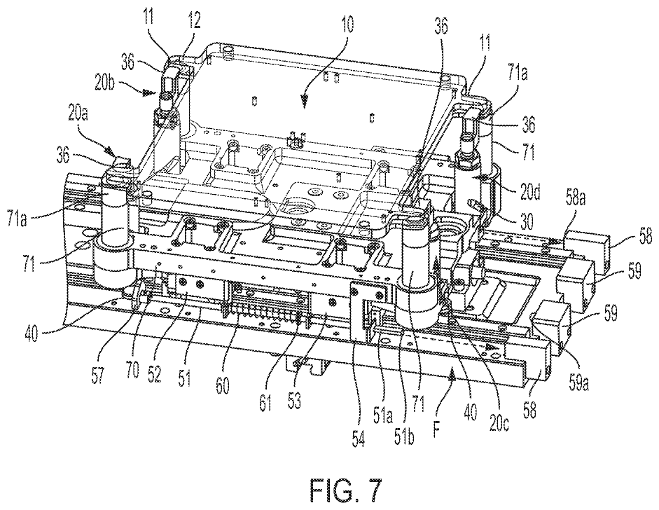

The clamp assemblies 20a-20d are actuated by an actuation assembly 50, as shown in FIGS. 4A-4B. The assembly 50 includes an actuation rod 51 that includes a non-circular end portion 51a terminating in a contact end 51b (FIG. 7). An actuation plate 57 is affixed to the opposite end of the actuation rod. The rod is supported by a series of brackets 52, 53, 54, and particularly by a respective flange 52a, 53a, 54a of the brackets. The flanges define an opening that the rod passes through to permit translation of the rod along its longitudinal axis. A limit plate 55, such as a snap ring, is affixed to the rod 51 on an outboard side of the flange 52a to limit the translation of the rod toward the flange 52a. As shown in FIGS. 7-9, the brackets 52, 53, 54 are fastened to a carriage 70 that supports the build plate 10, as described below. The brackets thus support the actuation rod 51 for translation to the left and right in FIGS. 4A and 7 relative to the carriage 70.

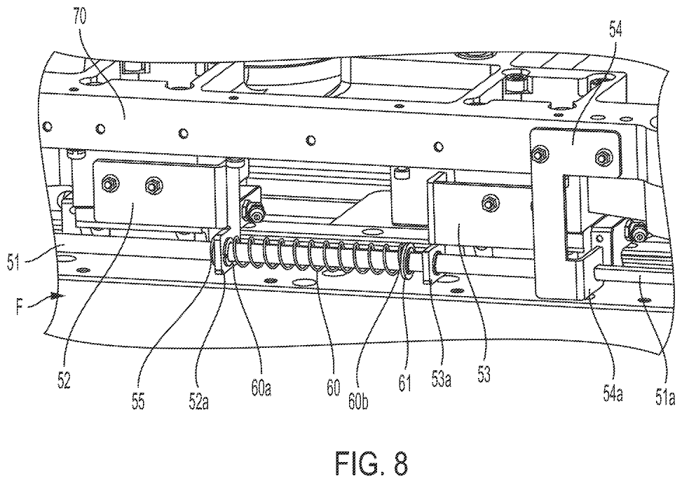

As shown in more detail in FIG. 8, the rod extends through a spring 60, with the spring disposed between the flange 52a and the flange 53a. One end 60a of the spring bears against the inboard side of the flange 52a. The opposite end 60b of the spring bears against a limit plate 61, such as a snap ring, that is attached to the rod 51 and movable with the rod. It can be appreciated that as the rod 51 moves to the left in FIG. 8, the limit plate 61 compresses the spring 60 against the flange 52a. It should also be appreciated that the compressed spring exerts a force to propel the rod to the right in FIG. 8 when the end 51b of the rod is unrestrained. The spring 60 thus defines the free or unloaded position of the actuation rod 51 relative to the carriage 70, and more importantly relative to the clamp assemblies 20.

Returning to FIGS. 4A-4B, further components of the actuation mechanism 50 are the actuation blocks 58, 59. Two of the blocks 58 are arranged so that the end 51b of each of the actuation rods 51 can contact an actuation face 58a of the blocks, as depicted in FIGS. 4A, 4B, 9 and 10. Two additional blocks 59, each including an actuation face 59a, are disposed between the two blocks 58. The actuation blocks 58, 59 are mounted to a fixed frame F of the 3D printing machine M. The actuation blocks 59 are aligned with two clamp assemblies 20c, d at the near end of the carriage 70, as shown in FIGS. 7-10. The actuation blocks 58 are aligned with the ends 51b of the actuation rods which are in turn aligned with the two clamp assemblies 20a, b at the far end of the carriage, relative to the fixed actuation blocks.

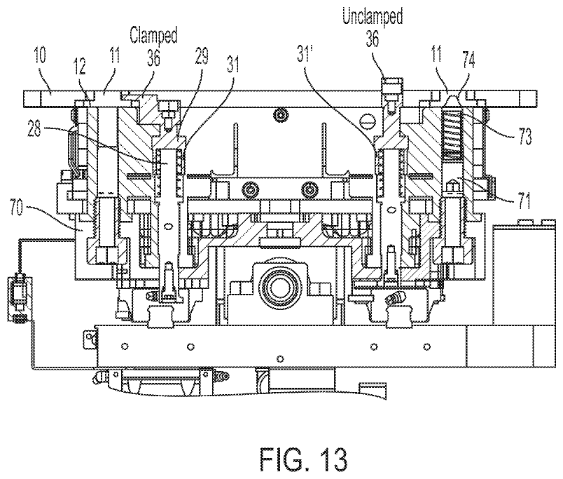

The carriage 70 supports the build plate 10 with support posts 71 (FIGS. 7, 8, 9). In particular, each of the tangs 11 of the build plate rest on a top surface 71a of a respective one of the posts 71. In the illustrated embodiment, four posts are provided to support the build plate at the tangs at the four corners of the plate. It can be appreciated that the underside of the tangs 11 and the surfaces 71a of the support posts can be configured to provide an alignment feature that prevents the build plate form slipping from the surfaces. For example, such a feature can include a tapered or conical centering post 73 (FIG. 13) projecting from the support posts into a complementary tapered or conical bore 74 in the bottom surface of the tangs 11. The centering posts 73 can be spring biased, as reflected in the drawing. Alternatively, the centering post can be integrated into the tang and the complementary bore defined in the support post. The support posts 71 support the build plate so that the ledges 12 of each of the tangs 11 are adjacent the clamping arm 36 of a corresponding clamp assembly 20a-20d. More specifically, the ledges are oriented so that the clamping arms 36 can be rotated into engagement with the ledges, as shown in FIGS. 2 and 7, and rotated out of engagement with the ledges, as shown in FIGS. 3, 9 and 10.

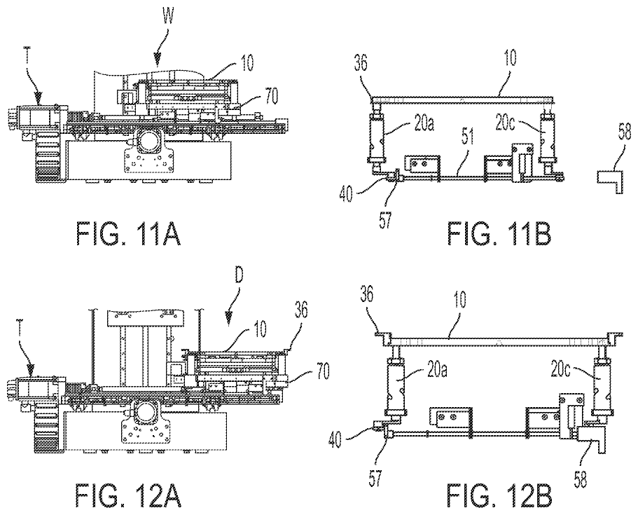

The operation of the clamp assemblies and actuation mechanism is essentially a function of the position of the carriage 70 supporting the build plate 10. When the carriage is in the working station W (FIG. 11A) below the print head H, the build plate 10 is locked onto the support posts 71 of the carriage, as shown best in FIG. 7. As described above, the build plate is locked by engagement of the clamp arms 36 of each of the clamp assemblies 20a-20d onto the ledges 12 of each tang 11 of the build plate. In the locked position, the guide pin 30 of all of the clamp assemblies 20a-20d is at the lower end 26a of the slots 25a, 25b. In this locked position, no force is applied to the roller 40 on the corresponding follower arm 38 of each clamp assembly. Thus, for the clamp assemblies 20a, b, the actuation plate 57 at the end of the actuation rod 51 is offset from the corresponding roller 40 because the spring 60 biases the rod 71 away from the roller 40. For the clamp assemblies 20c, d, the corresponding rollers are offset from the actuation faces 59a of the actuator blocks 79.

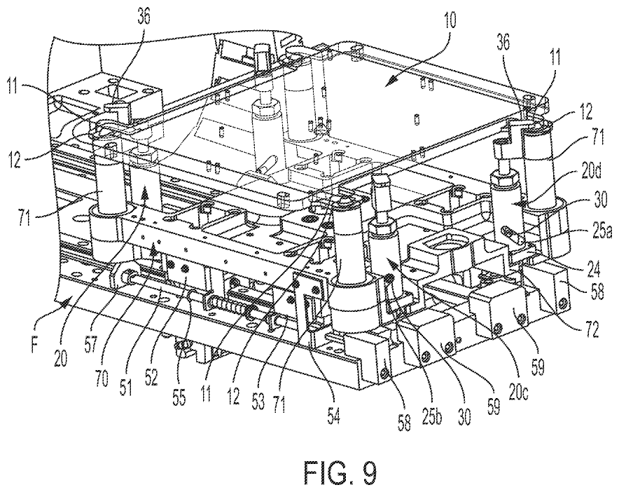

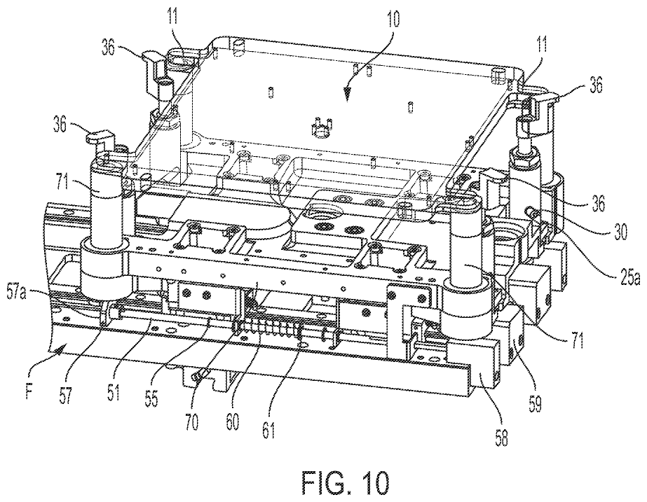

When it is desired to remove the build plate 10, the carriage 70 is moved away from the print head H and toward the stationary blocks to an unloading station D (FIG. 12A), such as by operation of the transfer mechanism T. As the build plate is being moved, the clamps 20 remain engaged on the build plate. In particular, the spring 31 of each clamp assembly pushes and holds the guide pin 30 against the lower end 26a of each slot 25a, 25b. As the carriage is driven by the transfer mechanism T to the stationary blocks at the unloading station D, the ends 51b of the two rods 51 contact the face 58a of the respective actuation blocks 58. At the same time, the rollers 40 of the clamp assemblies 20c, 20d contact the face 59a of the respective actuation blocks 59. As the transfer mechanism T drives the carriage closer to the stationary blocks, the rod 51, and in particular the actuation face 57a of the actuation plate 57, pushes the roller 40 of the clamp assemblies 20a, 20b. At the same time, the spring 60 is compressed about the rod 51. Simultaneously, the actuation blocks 59 push the rollers of the clamp assemblies 20c, 20d. This force causes the follower arm 38 of each clamp assembly 20a-20d to rotate within the corresponding cylinder 22, which in turn causes the corresponding shaft 28 to rotate. Since the clamp 35 is fixed to the shaft, rotation of the shaft produces rotation of the clamp, causing the clamp arm 36 of each clamp assembly 20a-20d to simultaneously rotate away from the tangs 11 of the build plate. The transverse pin 30 of each clamp assembly is fixed to the shaft 28, so the pin necessary rotates with the shaft. Since the pin is constrained within the opposing slots 25a, 25b, rotation of the pin causes it to travel upward within the slots, against the biasing force of the spring 31. This movement of the transverse pin 30 translates the shaft 28, and thus the clamp arm 36, upward to the unclamped position, clear of the build plate, as shown in FIGS. 9-10.

It can be noted that the clamp assemblies 20a-20d are all disposed between tangs 11 on the leading and trailing ends of the build plate. Thus, the mounting base 24 of the cylinders 22 of each of the clamp assemblies is supported within a recess 72 defined in the carriage 70 inboard of the support posts 71. This arrangement of the clamp assemblies is compact and allows the clamping system disclosed herein to fit within the close spaces available in a typical 3D printing machine M. Due to this arrangement of the clamp assemblies, the direction of rotation to the unclamped position is different for pairs of clamp assemblies. In other words, clamp assemblies 20a and 20d rotate clockwise to release the respective clamp arms 36 from the build plate. The clamp assemblies 20b and 20c rotate counter-clockwise to release the build plate. Conversely, to clamp the build plate, the clamp assemblies 20a, 20d rotate counter-clockwise and the clamp assemblies 20b, 20c rotate clockwise. This difference in rotation direction is accomplished by the particular orientation of the opposed slots 25a, 25b and by the position of the follower arm 38 carrying the roller 40. As best seen in FIG. 4, the slots 25a of clamp assemblies 20a and 20d face the stationary blocks, while the opposite slots 25b of clamp assemblies 20b and 20c face the stationary blocks. In addition, the follower arms 38 of clamp assemblies 20a and 20d face left in the figure, while the follower arms 38 of clamp assemblies 20b and 20b face right.

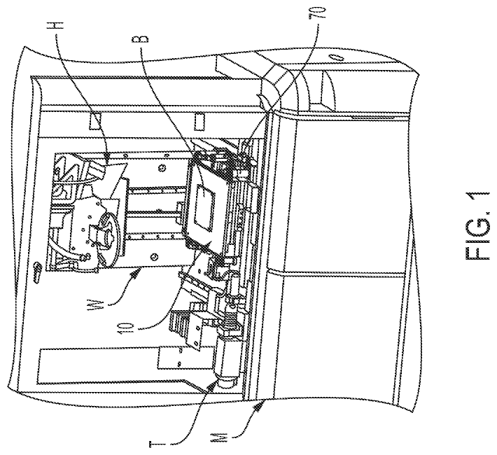

With the carriage 70 at the unloading station D adjacent the stationary actuation blocks 58, 59, the clamp assemblies 20a-20d have released the build plate 10 so that it can be removed from the printing machine M with the newly created build B (FIG. 1). A new build plate can then be placed on the support posts 71 of the carriage 70. The carriage 70 can then be retracted from the actuation blocks, such as by operation of the transfer mechanism T, and moved to the working station W. As the carriage moves away from the blocks (i.e., to the left in FIGS. 7-9), the rollers 40 disengage their respective actuation faces—i.e., the rollers of clamp assemblies 20a, 20b disengage the actuation plates 57 and the rollers of clamp assemblies 20c, 20d disengage the actuation faces 59a of the blocks 59. Moreover, as the carriage moves away, the end 51b of the actuation rod loses contact with the actuation face 58a of the actuation block 58, and at the same time the spring 60 of the actuation rod 51 extends to its uncompressed length shown in FIG. 7.

The spring 31 within each clamp assembly push the respective shaft 28 downward, and as the transverse pin 30 also moves downward within the slots 25a, 25b toward the lower end 26a, the clamp arm 36 and follower 38 rotate to the disengaged position. As shown in FIG. 13, the spring 31 is in its lengthened state when it pushes the clamping arm down, as identified by the feature number “36 clamped”. When the shaft 28 is rotated to drive the transverse pin 30, and thus the clamping arm 36, upward, the spring is in its compressed state 31′ with the clamping arm designated as “36 unclamped”. It can be appreciated that the spring 31 has a spring constant that is sufficient to drive the clamping arm 36 down with sufficient force to clamp the build plate 10 on the support posts 71. In a specific embodiment, the springs have a free length of 2 in., a length in the clamped position of 1.4 in., and a length in the unclamped position of 0.9 in. The spring can have a spring constant of 9.56 lb/in, so that the spring generates a clamping force of 5.74 lb. In the unclamped position, the spring is generating a downward force of 10.52 lb., which is sufficient to drive the shaft 28 downward as the build frame moves to its unclamped condition.

The clamping system disclosed herein avoids the pitfalls of the pneumatic and hydraulic clamps of the prior art. In particular, since the clamp assemblies 20 and actuation mechanism 50 are mechanical, they are not susceptible to the high temperature environment of the 3D printing machine M, particular where the 3D printing uses molten metal. Moreover, the clamping system disclosed herein is contained within the envelope of the build plate 10 and carriage 70 and can be incorporated into the 3d printing machine without significant modification to the existing components. Furthermore, the mechanical nature of the clamp assemblies and actuation mechanism makes the clamping system more resistant to break down than the prior hydraulic and pneumatic systems.

It will be appreciated that variants of the above-disclosed and other features, and functions, or alternatives thereof, may be desirably combined into many other different machines, systems or applications. Various presently unforeseen or unanticipated alternatives, modifications, variations, or improvements therein may be subsequently made by those skilled in the art, which are also intended to be encompassed by the following claims.

For example, the clamp assemblies 20 in the disclosed embodiment are positioned adjacent a corresponding support post 71 on which the build plate 10 rests. The clamping arms 36 are arranged to be above the support posts in the clamping position. Alternatively, the clamp assemblies can be arranged to engage another portion of the build plate 10 to exert a downward force on the build plate, pressing it against the support posts. In another example, the spring 31 in the clamp assemblies is a compression spring that exerts a downward force on the shaft 28. Alternatively, the spring can be a torsion spring that applies a twisting force on the shaft to cause the shaft to rotate within the cylinder 22. In a further alternative, a spring arrangement can engage the transverse pin 30 to pull the pin to the bottom end 26a of the opposing slots 25a, 25b.

In the illustrated embodiment, the follower arms 38 of each of the clamp assemblies contacts a corresponding actuation face 57a, 59a to move the clamping arms 36 to their unclamped positions. In particular, the actuation mechanism 50 is operable when the carriage 70 moves away from the position underneath the print head H of the 3D printing machine M. Alternatively, the actuation mechanism can be configured so that the actuation faces contact the follower arms when the carriage is underneath the print head. In this configuration, the clamp assemblies would be oriented so that rotation of the follower arms 38 by contact with the actuation faces rotates the clamping arms 36 into their clamped positions.

What is claimed is:

1. A clamping system for a build plate of a 3D printing machine, in which the build plate is supported on a plurality of support posts mounted on a carriage within the 3D printing machine, the carriage movable by a powered transfer mechanism between a working station aligned with a print head of the machine and an unloading station offset from the print head, in which the build plate includes a plurality of clamping surfaces, the clamping system comprising:
a plurality of clamp assemblies mountable on the movable carriage, each of the plurality of clamp assemblies including;
a clamping arm configured and arranged to selectively engage and disengage a corresponding one of the plurality of clamping surfaces of the build plate;
a follower arm separate from said clamping arm; and
a conversion mechanism disposed between said clamping arm and said follower arm, said conversion mechanism configured to move said clamping arm in response to force being applied to said follower arm; and
an actuation mechanism including a plurality of actuation faces, each actuation face corresponding to the follower arm of a corresponding one of said plurality of clamp assemblies, said actuation mechanism configured so that said plurality of actuation faces simultaneously apply a force against said corresponding follower arm as the carriage is moved by the powered transfer mechanism between the working station and the unloading station of the 3D printing machine.

2. The clamping system of claim 1, wherein said conversion mechanism includes a biasing member configured to exert a biasing force opposite said force applied by the corresponding actuation face against the follower arm.

3. The clamping system of claim 1, wherein each of said plurality of clamp assemblies includes:
an elongated hollow cylinder defining a longitudinal axis from one end to an opposite end thereof and a bore along said longitudinal axis;
said clamping arm disposed outside said cylinder at said one end and extending transverse to said longitudinal axis;
said follower arm disposed outside said cylinder at said opposite end and extending transverse to said longitudinal axis; and
said conversion mechanism incorporated into said cylinder.

4. The clamping system of claim 3, wherein:
said clamping arm is supported relative to said cylinder for rotation about and translation along said longitudinal axis to selectively engage and disengage a corresponding one of the plurality of clamping surfaces of the build plate;
said follower arm is supported relative to said cylinder for rotation about said longitudinal axis; and
said conversion mechanism is configured to convert said rotation of said follower arm to said rotation and translation of said clamping arm.

5. The clamping system of claim 4, wherein said conversion mechanism includes a biasing member configured to exert a biasing force against rotation of said follower arm by said actuation mechanism.

6. The clamping system of claim 4, wherein said conversion mechanism includes;
at least one slot extending through said cylinder in communication with said bore, said at least one elongated slot defined at a non-colinear and non-perpendicular angle relative to the longitudinal axis of the cylinder and having a first end that is lower than an opposite second end relative to said cylinder;
an elongated shaft extending through said bore, said shaft being rotatable and translatable within said bore along the longitudinal axis of the cylinder, wherein said clamping arm and said follower arm are fixed to opposite ends of said elongated shaft and rotate with said shaft; and
a guide pin extending outward from said shaft and disposed within said at least one slot for movement along a length of said slot between said first end and said second end as the shaft rotates within said cylinder,
whereby rotation of said shaft causes said guide pin to move within said at least one slot toward one of said first end and said second end, and
whereby as said guide pin moves within said slot, said shaft translates within said cylinder to raise and/or lower the clamping arm relative to said cylinder and relative to the respective clamping surface of the build plate as said clamping arm rotates.

7. The clamping system of claim 6, wherein said conversion mechanism is configured so that said clamping arm is raised relative to said cylinder when said guide pin is moved toward said second end of said at least one slot, and said clamping arm is lowered relative to said cylinder when said guide pin is moved toward said first end of said at least one slot.

8. The clamping system of claim 6, wherein:
said at least one slot includes two diametrically opposite slots defined in said cylinder in communication with said bore; and
said guide pin extends outward from said shaft and is disposed within each of said two slots.

9. The clamping system of claim 6, wherein said at least one slot is arranged at an angle of 45° relative to said longitudinal axis.

10. The clamping system of claim 6, wherein:
said conversion mechanism includes a biasing member configured to exert a biasing force against rotation of said follower arm by said actuation mechanism;
said elongated shaft includes a hub disposed within said bore; and
said cylinder includes a bearing mount at said one end configured to rotatably support said shaft,
wherein said biasing member is a spring disposed within said bore between said hub and said bearing mount, and configured to exert said biasing force against said hub of said elongated shaft.

11. The clamping system of claim 4, wherein said plurality of clamp assemblies includes a number of conversion mechanisms configured to translate said clamping arm in a first direction upon rotation of said follower arm in a clockwise direction, and a like number of conversion mechanisms configured to translate said clamping arm in said first direction upon rotation of said follower arm in a counter-clockwise direction.

12. The clamping system of claim 1, in which the build plate is generally rectangular and includes a clamping surface at each of the four corners of the build plate, wherein said plurality of clamp assemblies includes four clamp assemblies, each of the four clamp assemblies arranged to exert a clamping force on the clamping surface at a corresponding corner of the build plate.

13. The clamping system of claim 1, wherein said actuation mechanism includes at least one actuation block fixed within the 3D printing machine relative to the carriage, said at least one actuation block defining said actuation face corresponding to the follower arm of at least one of said plurality of clamp assemblies, wherein said force is applied against said follower arm by contact with said actuation face of said at least one actuation block when said carriage is moved by the powered transfer mechanism toward said unloading station.

14. The clamping system of claim 1, wherein said actuation mechanism includes:
at least one elongated actuation rod supported for translation relative to said carriage, said actuation rod including an actuation plate at one end and a contact end at an opposite end thereof, said actuation plate defining said actuation face corresponding to the follower arm of one of said plurality of clamp assemblies; and
at least one actuation block fixed within the 3D printing machine relative to said carriage, said at least one actuation block defining an additional actuation face arranged to contact said contact end of said actuation rod when said carriage is moved by the powered transfer mechanism toward said unloading station,
wherein said force is applied against said follower arm by contact with said actuation face of said actuation plate and by contact of said contact end of said actuation rod against said actuation block when said carriage is moved by the powered transfer mechanism toward said unloading station.

15. The clamping system of claim 14, further comprising a biasing spring operable on said actuation rod to bias said actuation plate away from contact with said corresponding follower arm.

16. A 3D printing machine comprising:
a print head at a working station;
an unloading station offset from said working station;
a carriage movable between said working station and said unloading station;
a powered transfer mechanism operable to move said carriage between said working station and said unloading station;
a build plate supported on a plurality of support posts mounted on the carriage the build plate including a plurality of clamping surfaces; and
a clamping system comprising:
a plurality of clamp assemblies mounted on the movable carriage, each of the plurality of clamp assemblies including;
a clamping arm configured and arranged to selectively engage and disengage a corresponding one of the plurality of clamping surfaces of the build plate;
a follower arm separate from said clamping arm; and
a conversion mechanism disposed between said clamping arm and said follower arm, said conversion mechanism configured to move said clamping arm in response to force being applied to said follower arm; and
an actuation mechanism including a plurality of actuation faces, each actuation face corresponding to the follower arm of a corresponding one of said plurality of clamp assemblies, said actuation mechanism configured so that said plurality of actuation faces simultaneously apply a force against said corresponding follower arm as the carriage is moved by said powered transfer mechanism between the working station and the unloading station of the 3D printing machine.

17. The 3D printing machine of claim 16, wherein each of said plurality of clamp assemblies includes:
an elongated hollow cylinder defining a longitudinal axis from one end to an opposite end thereof and a bore along said longitudinal axis;
said clamping arm disposed outside said cylinder at said one end and extending transverse to said longitudinal axis;
said follower arm disposed outside said cylinder at said opposite end and extending transverse to said longitudinal axis; and
said conversion mechanism incorporated into said cylinder.

18. The 3D printing machine of claim 17, wherein said cylinder of each of said plurality of clamp assemblies is mounted on said carriage adjacent a corresponding one of said plurality of support posts.

19. The 3D printing machine of claim 17, wherein:
said carriage and said build plate are generally rectangular;
said plurality of support posts include four support posts disposed at the corners of the generally rectangular carriage; and
said plurality of clamp assemblies includes four clamp assemblies, with two clamp assemblies mounted on the carriage between two support posts.

20. The 3D printing machine of claim 19, wherein:
said build plate includes a tang at each corner of the generally rectangular build plate, each tang arranged to be supported on corresponding one of the four support posts; and
said tang including a ledge facing an adjacent clamp assembly for engagement by said clamping arm of the adjacent clamp assembly.
